(19) United States
(12) Patent Application Publication
(10) Pub. No.: US 2007/0165913 A1
(43) Pub. Date: Jul. 19, 2007

(54) Fingerprint detecting method

(76) Inventors: Eer Wen Tyan, Hsin-Chu (TW); Shih Shien Hsu, Hsin-Chu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/324,289

(22) Filed: Jan. 4, 2006

(30) Foreign Application Priority Data
Jan. 11, 2005 (TW) 94100705

(51) Int. Cl. G06K 9/00

(52) U.S. Cl. 382/124

(57) ABSTRACT

The claimed invention discloses a fingerprint detecting method. Firstly, providing an object, sliding the object on the image capturing area, and making the image capturing area sequentially producing a plurality of first images to the image processor in a measure period. The image processor sequentially compares overlaps of each first image and produces a first moving rate. The image capturing area uniformly captures images with the first moving rate and produces a plurality of second images to the image processor. The image processor sequentially combines each second image to form a fingerprint image. The claimed invention can effectively lower the arithmetic while combining images, reduce the probability of fingerprint image distortion, and improve the fingerprint identification rate.

### BACKGROUND OF INVENTION

1. Field of the Invention

The invention relates to a detecting method, and more particularly, to a fingerprint detecting method with less arithmetic and low power consumption.

2. Description of the Prior Art

The conventional fingerprint scanning detector always samples images with a fixed scanning rate, and the images have different overlaps caused by different finger moving speed. After outputting the images, the image processor will find out the best overlaps between each image and the next one and delete repetitions to combine images and form a complete fingerprint.

However, because of the sampling time of the detector, the best overlaps between images are just similar but different. The error can be 0 to ±½ pixel, and be accumulated with times of image combination. It's the major cause of the fingerprint distortion. Furthermore, since the finger moving speeds are different in every sampling, the accumulated errors are also different. This makes the difficulty in comparing the fingerprints and lowers the identification rate. Generally, this kind of error is corrected by the interpolation calculation that the errors are found out from the overlapped images and a new image point is then produced from two adjacent points, whose images are not overlapped, by using the interpolation calculation, wherein the shift amount of the new point equals to the calculated error. This method can theoretically solve the difficulty of image combination, but this method has a huge amount of calculation and cannot be applied to the platform of low arithmetic and low power consumption.

Hence, with the accumulated experience of performing the production designing and manufacturing, the present invention discloses a fingerprint detecting method with less arithmetic and low power consumption to effectively solve the above-mentioned problem.

### SUMMARY OF INVENTION

It is therefore a primary objective of the claimed invention to provide a fingerprint detecting method that can effectively lower the arithmetic while combining images, and then reduce the power consumption.

It is therefore another objective of the claimed invention to provide a fingerprint detecting method that can reduce the probability of fingerprint image distortion, and improve the fingerprint identification rate.

According to the claimed invention, a fingerprint detecting method includes providing an object, sliding the object on the image capturing area of the linear fingerprint identification apparatus and capturing images in the image capturing area, the image capturing area sequentially produces a plurality of first images to the image processor in a measure period; sequentially comparing overlaps of each first image in the image processor and producing a first moving rate; and uniformly capturing images with the first moving rate in the image capturing area and producing a plurality of second images to the image processor, the image processor sequentially combines each second image to form a fingerprint image.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a structural diagram of the present invention.

FIG. 2 is an operational flow chart of the present invention.

FIG. 3 is an operational flow chart of the present invention with the tuning procedure.

| | | | |
|---|---|---|---|
| 10 | fingerprint identification apparatus | 12 | image capturing area |
| 14 | image processor | 16 | standard fingerprint image |
| 18 | tolerance | 20 | object |

### DETAILED DESCRIPTION

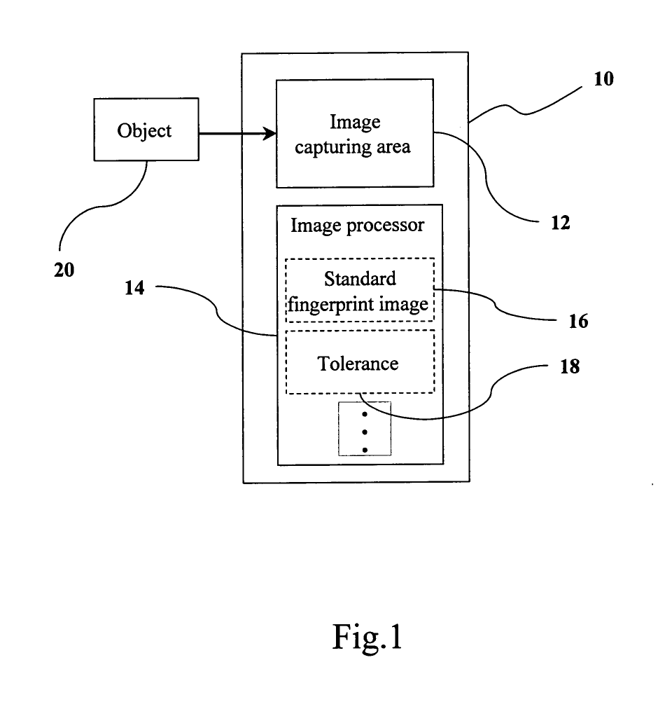

The present invention discloses a fingerprint detecting method for providing to a linear fingerprint identification apparatus. Please refer to FIG. 1, the linear fingerprint identification apparatus 10 includes an image capturing area 12 and an image processor 14. The image capturing area 12 includes one of charge-coupled device (CCD) and complementary metal oxide semiconductor (CMOS), and the captured images in the image capturing area 12 have at least 4 pixels length and at least 128 pixels width. The image processor 14 is stored a standard fingerprint image 16 and a predetermined tolerance 18. The tolerance 18 is the allowable human error while detecting, such as the moving speed of fingers, and the tolerance 18 is less than ¼ pixel.

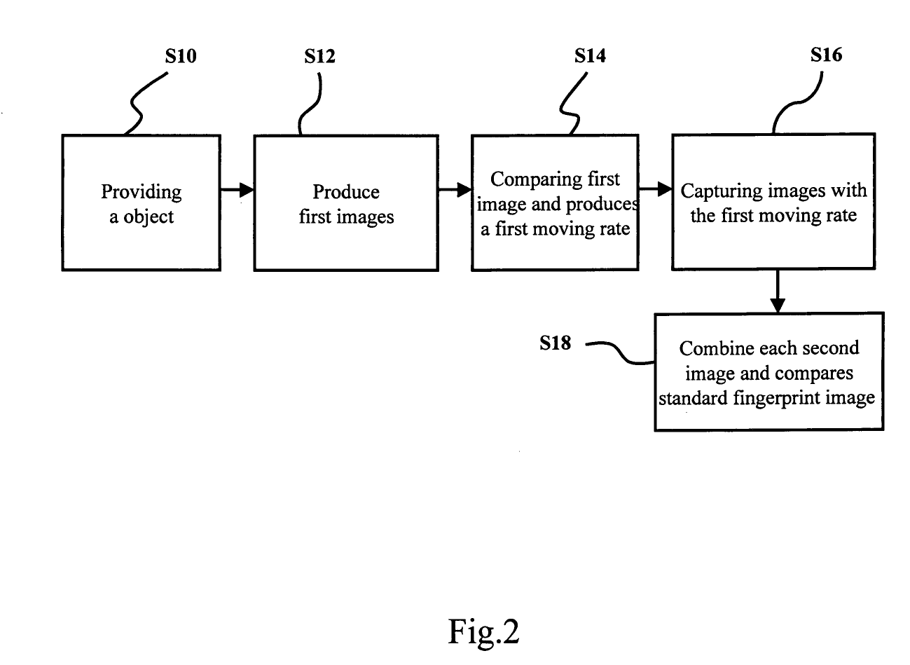

Please refer to FIG. 2, the fingerprint detecting method firstly performs the step S10 that providing a object 20. The object 20 is the fingerprint of the operator. Then, the step S12 is performed that sliding the object 20 from top to down once on the image capturing area 12 and capturing images in the image capturing area 12. In the step S12, the image capturing area 12 sequentially produces at least three first images to the image processor 14 in a measure period, and then the image processor 14 sequentially compares overlaps of each first image and produces a first moving rate, as shown in step S14. In the step S16, the image capturing area 12 uniformly captures images with the first moving rate and produces a plurality of second images to the image processor 14. In the step S18, the image processor 14 sequentially combines each second image to form a fingerprint image, and the image processor 14 compares the fingerprint image with the standard fingerprint image 16.

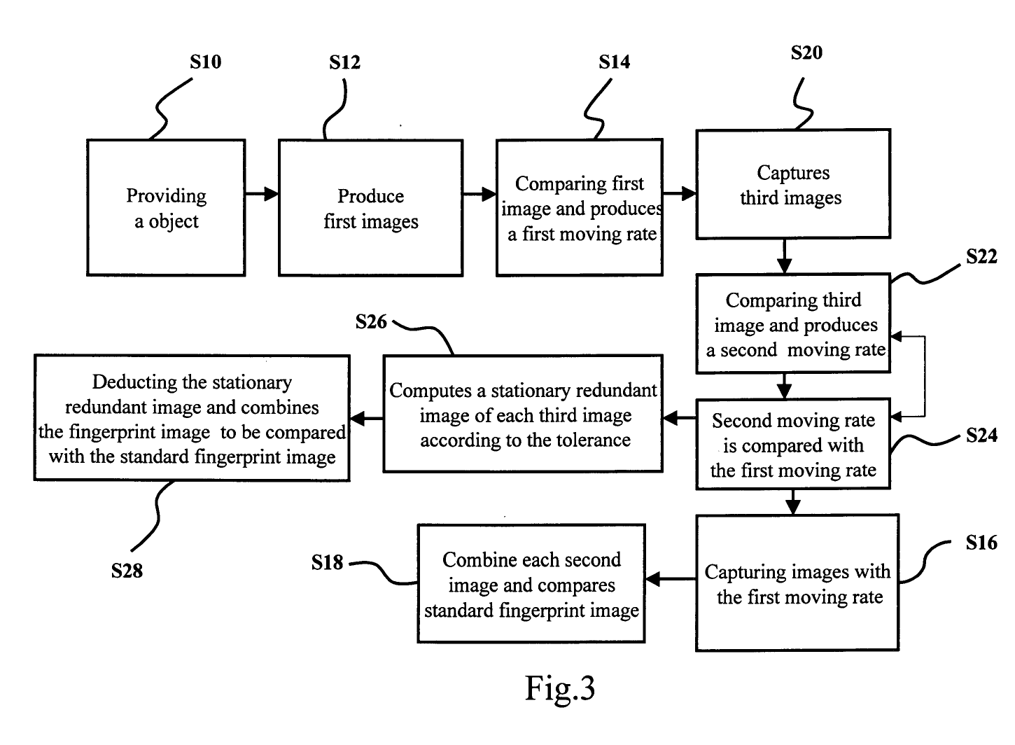

While beginning to sample with the image capturing area 12, the moving speed of the object 20 is likely unstable, even stopping moving, so a tuning procedure should be further added between the steps S14 and S16. Please refer to FIG. 3, the tuning procedure is continuously performed from steps S20 to S24. In the step S20, the image capturing area 12 captures at least two third images, and in step S22, the image processor 14 compares overlaps of each third image and produces a second moving rate. Then, in the step S24, the second moving rate is compared with the first moving rate, if they are the same or in the predetermined tolerance 18, the next step will be performed, and if they are different or not in the predetermined tolerance 18, the first moving rate will be adjusted proportionally and the tuning procedure will be repeated.

If the first and the second moving rates are the same, the same steps 16 to 18 will be performed. The image processor 14 will compare the fingerprint image with the standard fingerprint image 16.

If the difference between the first and the second moving rates exceeds the tolerance 18, the step S26 will be performed. The image processor 14 computes a stationary redundant image of each third image according to the tolerance 18, and range of the stationary redundant image is between 0 pixel and ¼ pixel. Finally, in the step S28, when the image processor 14 sequentially combines each third image, the stationary redundant image will be deducted and the fingerprint image will be formed to be compared with the standard fingerprint image 16.

By detecting the finger moving speed in advance, the arithmetic of the image processor 14 in image combination can be substantially simplified, and the power consumption of the fingerprint identification apparatus 10 can be also substantially reduced. In addition, by detecting the finger moving speed in advance, the probability of fingerprint image distortion caused by image combination can be further reduced and the fingerprint identification rate can be improved.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A fingerprint detecting method for providing to a linear fingerprint identification apparatus, the linear fingerprint identification apparatus comprises an image capturing area and an image processor, the method of finger detection comprising:
providing an object, sliding the object on the image capturing area and capturing images in the image capturing area, the image capturing area sequentially produces a plurality of first images to the image processor in a measure period;
sequentially comparing overlaps of each first image in the image processor and producing a first moving rate; and
uniformly capturing images with the first moving rate in the image capturing area and producing a plurality of second images to the image processor, the image processor sequentially combines each second image to form a fingerprint image.

2. The fingerprint detecting method of claim 1, wherein the image processor is further stored at least one standard fingerprint image for comparing with the fingerprint image.

3. The fingerprint detecting method of claim 1, wherein the image capturing area comprises one of charge-coupled device (CCD) and complementary metal oxide semiconductor (CMOS).

4. The fingerprint detecting method of claim 1, wherein captured images in the image capturing area have at least 4 pixels length and at least 128 pixels width.

5. The fingerprint detecting method of claim 1, wherein, after producing the first moving rate, further comprises a tuning procedure that capturing a plurality of third images in the image capturing area, comparing overlaps of each third image in the image processor and producing a second moving rate, and comparing the second moving rate with the first moving rate, if they are the same or in a predetermined tolerance, the next step is performed, and if they are different or not in the predetermined tolerance, the tuning procedure is repeated and compared with the second moving rate.

6. The fingerprint detecting method of claim 5, wherein the predetermined tolerance is ¼ pixel and the predetermined tolerance is stored in the image processor.

7. The fingerprint detecting method of claim 5, wherein when the first moving rate is in the predetermined tolerance, the image processor computes a stationary redundant image of each second image according to the predetermined tolerance.

8. The fingerprint detecting method of claim 7, wherein range of the stationary redundant image is between 0 pixel and ¼ pixel.
